(19) United States
(12) Patent Application Publication
(10) Pub. No.: US 2026/0370089 A1
(43) Pub. Date: Nov. 19, 2026

(54) DUAL ROTOR AXIAL FLUX GENERATOR

(71) Applicant: AIRGREENING (CANADA) INC., Markham (CA)

(72) Inventors: Jixian HU, Richmond Hill (CA); Yuehao HU, Richmond Hill (CA); Jiawen ZHU, Toronto (CA); Pengyi LIAO, Brossard (CA)

(21) Appl. No.: 19/096,061

(22) Filed: Mar. 31, 2025

Related U.S. Application Data
(63) Continuation of application No. PCT/IB2025/053313, filed on Mar. 28, 2025.

(51) Int. Cl. H02K 7/18; H02K 1/16; H02K 3/26; H02K 16/02

(52) U.S. Cl. CPC H02K 7/183; H02K 1/16; H02K 3/26; H02K 16/02

(57) ABSTRACT

A generator that includes a housing and a stator fixedly supported on the housing. The generator further includes a first rotor on a first side of the stator supported on a first shaft. The first shaft is rotatably supported on the housing. The generator also includes a second rotor on a second side of the stator opposite the first rotor. The second rotor is supported on a second shaft and configured to rotate independently from the first rotor. The second shaft is rotatably supported on the housing.

### FIELD

The specification relates generally to electric generators, and specifically to dual rotor axial flux generators.

### BACKGROUND

Wind energy is an increasingly relied on renewable energy source for power generation. The power a wind turbine captures is proportional to the swept area by the rotor blades, making larger rotors of up to about 80 m long for onshore turbines and up to about 110 m long for offshore turbines, a design trend. However, these large turbines typically require about 10 to about 13 m/s wind speeds to reach their rated power output and wind speeds within that range account for less than 20% of the total wind energy resources while most available wind energy falls within the about 3 to about 10 m/s wind speed range, at which these turbines fail to achieve optimal efficiency.

### SUMMARY

An aspect of the specification provides a generator that includes a housing and a stator fixedly supported on the housing. The generator further includes a first rotor on a first side of the stator supported on a first shaft. The first shaft is rotatably supported on the housing. The generator also includes a second rotor on a second side of the stator opposite the first rotor. The second rotor is supported on a second shaft and configured to rotate independently from the first rotor. The second shaft is rotatably supported on the housing.

### BRIEF DESCRIPTIONS OF THE DRAWINGS

Embodiments are described with reference to the following figures. In the figures provided, certain components or details may have been omitted for clarity and conciseness. However, it is understood that these elements will be readily apparent to those skilled in the art and are considered within the scope of the disclosure.

FIG. 1 depicts a top, front and left perspective view of an example wind turbine.

FIG. 2 depicts an exploded view of some components of an example dual rotor generator of the example wind turbine of FIG. 1.

FIG. 3 depicts a front plan view of the example dual rotor generator of FIG. 2.

FIG. 4 depicts a top, front and left perspective view of a housing of the example dual rotor generator of FIGS. 2 and 3.

FIG. 5 depicts an exploded view of some components of the example dual rotor generator of FIGS. 2 and 3.

FIG. 6 depicts a close-up front plan view of some components of the example dual rotor generator of FIGS. 2 and 3.

### DETAILED DESCRIPTION

The power coefficient (C_{P}) is a measure of a wind turbine's efficiency in converting wind energy into mechanical power. It is calculated using the formula:

Cp=P_{turbine}/P_{wind} (1)

where P_{turbine} is the power output of the turbine and P_{wind} is the input power from the wind and is given by:

P_{wind}=0.5ρAv³ (2)

where ρ represents the density of air, A is the swept area of the turbine blades, and v is the wind speed. Conventional wind turbines typically achieve a C_{P} in the range of about 0.35 up to about 0.5. However, designs incorporating two blade assemblies, for example, where the blade assemblies rotate in opposite directions relative to each other, can improve wind energy utilization by effectively harvesting wind energy twice. These designs can achieve a C_{P} above 0.7, enhancing energy efficiency compared to conventional turbines.

For example, a wind turbine design with two blade assemblies where one assembly is configured to rotate the rotor of the wind turbine's generator and the other assembly is configured to rotate the stator of the wind turbine's generator, can enhance the efficiency of the wind turbine by harvesting the wind energy twice, as discussed above. However, this configuration presents challenges. Since the electrical wiring of the generator is in rotation, transferring electrical energy from the rotating components can require additional elements such as, for example, a set of carbon brushes, which experience continuous friction and wear and require regular cleaning and replacement, increasing both material costs and maintenance costs for the wind turbine. A wind turbine design with two blade assemblies and a brushless generator, for example, where each of the two assemblies is configured to rotate a rotor of the wind turbine's brushless generator can enhance the efficiency of the wind turbine at lower wind speeds with respect to that of conventional wind turbines without requiring the regular cleaning and parts replacement associated with brushed generators.

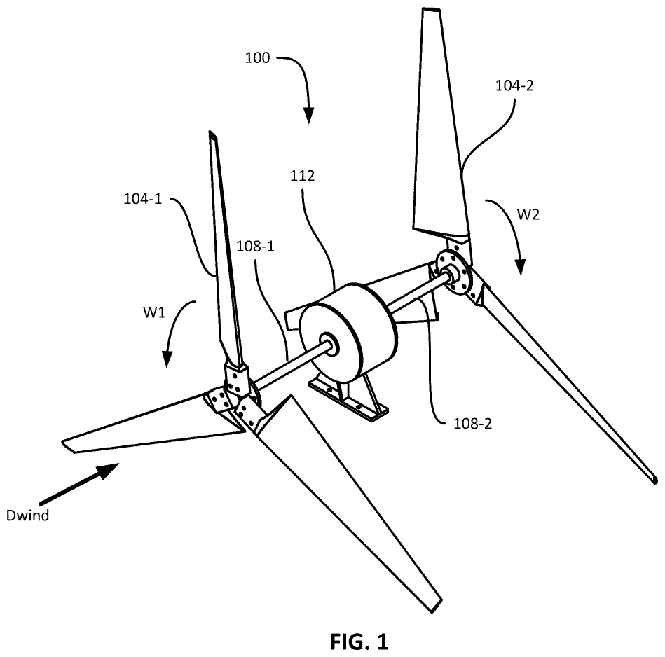

FIG. 1 depicts an example wind turbine 100 with an example dual rotor generator. The example wind turbine 100 includes two blade assemblies 104-1 and 104-2, commonly referred to as the blade assemblies (or the assemblies) 104 and individually referred to as a blade assembly (or an assembly) 104. This nomenclature is used elsewhere within the specification. Each of the blade assemblies 104 is supported on a shaft 108. The shafts 108 are rotatably supported on a dual rotor generator 112. The shafts 108 can be parallel with respect to each other; furthermore, the shafts 108 can be colinear with respect to each other. The blades of assembly 104-1 can be oriented in an opposite direction to the blades of assembly 104-2 so that the assemblies 104 may rotate in an opposite direction with respect to each other. Alternatively, the blades of the assemblies 104 can be oriented in the same direction so that the assemblies 104 may rotate in the same direction with respect to each other.

The blades of the assemblies 104-1 and 104-2 may further be provided with control elements such as a wind direction sensor, a blade pitch angle adjustment mechanism, blade assembly angular velocity sensors, etc., to control the rotation of the blade assemblies 104, for example, so that the absolute values of their angular velocities |w₁| and |w₂|, respectively, may be maintained equal to each other regardless of whether the blade assemblies 104 are configured to rotate in the same or opposite direction with respect to each other, and additionally, to maximize the energy capture, for example, by adjusting the angles of the blades based on the wind blowing direction. Alternatively or additionally, the wind turbine 100 may be further configured to adjust the yaw angle of the entire turbine 100 based on the wind blowing direction D_{wind} to face the wind direction D_{wind}, to maximize the energy capture, with the wind flowing through the first blade assembly 104-1 first and through the second blade assembly 104-2 afterward, the first blade assembly 104-1 thereby becoming an upwind blade assembly and the second blade assembly 104-2 thereby becoming a downwind blade assembly, as shown in FIG. 1. The blades of the second (downwind) blade assembly 104-2 can be, for example, maintained at fixed or selected pitch angles so that wind flowing through them rotates the turbine 100 to a yaw angle of 0° with respect to the wind direction D_{wind} without the wind turbine 100 requiring a separate rotation mechanism.

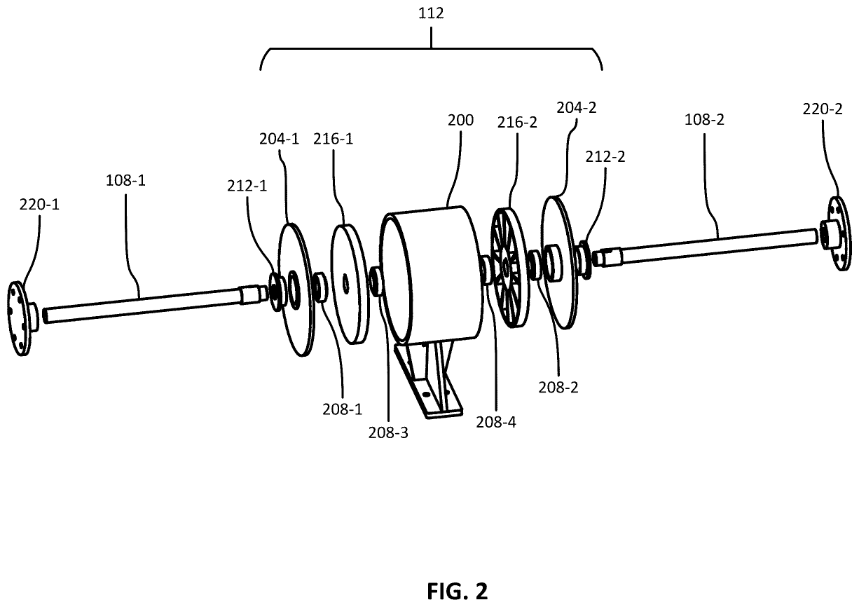

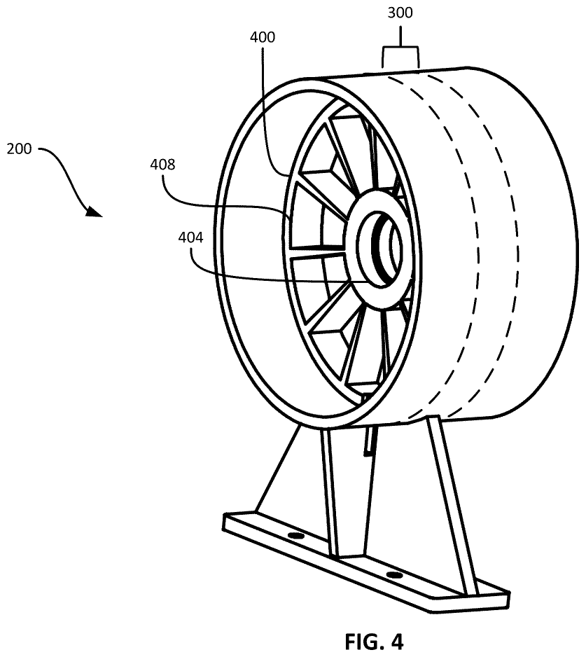

FIG. 2 depicts an exploded view of the example generator 112. The generator 112 includes a housing 200. The housing 200 can have a cylindrical shape, alternatively the housing 200 may have other shapes, for example, an ellipsoid shape, a rectangular prism, etc. The housing 200 includes two circular covers or plates 204 on opposite ends of the housing 200. Each of the plates 204-1 and 204-2 includes a bearing array 208-1 and 208-2, respectively, arranged at the center of the plate 204. The plates 204 are further provided with bearing covers 212-1 and 212-2 that may be configured to house the bearing arrays 208-1 and 208-2, respectively, and to secure the bearing arrays to 208-1 and 208-2 to the plates 204. FIG. 2 also shows bearing arrays 208-3 and 208-4 (discussed further below with reference to FIG. 4). The bearing arrays 208 can be arrays of roller bearings, for example, or tapered roller bearings.

The bearing arrays 208 rotatably support the shafts 108 on the housing 200. In an alternative embodiment, the shafts 108 may be rotatably supported on the housing 200 by means of, for example, bushings or sleeve bearings. The generator 112 includes two rotors 216-1 and 216-2 supported within the housing 200. Each of the rotors 216 is supported on a respective one of the shafts 108, so that the rotors 216 are colinear with respect to each other. The rotors 216 can be supported on the shafts, for example, by means of a keyed connection where either one of the shafts 108 or the rotors 216 is provided with a key and the other one is provided with a corresponding keyway so that torque is transmitted from the shaft 108 to the rotor 216 without slippage. The keyed connection can be secured, for example, by means of a retaining ring, locking nut, set of screws, etc. Alternatively, a different connection can be used to support the rotors 216 on the shafts 108, for example, a spline connection, a tapered shaft and hub connection, an interference fit connection, etc. FIG. 2 further shows two bolted flanges 220, each of which is supported on one of the shafts 108 and to which a respective one of the blade assemblies 104 can be affixed, for example, by securing the blade roots to the flanges 220 through a set of bolts.

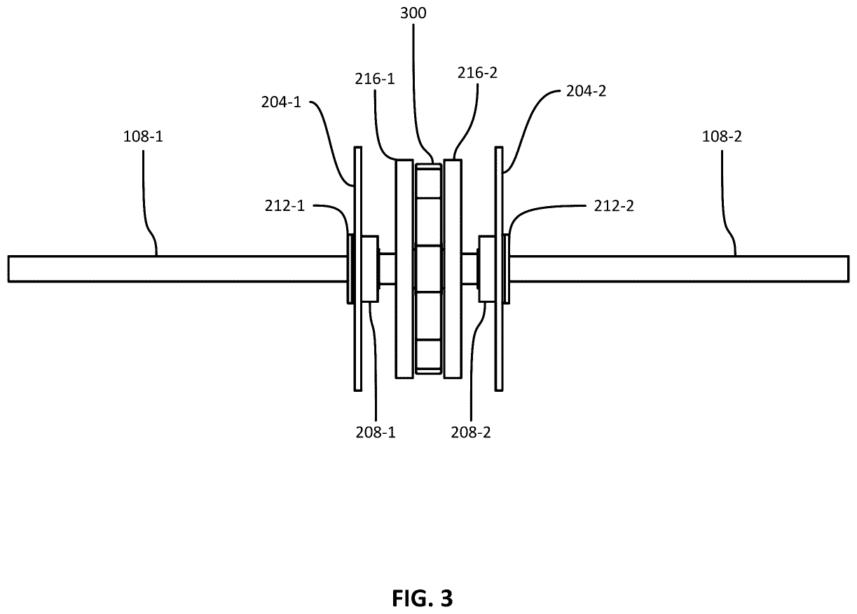

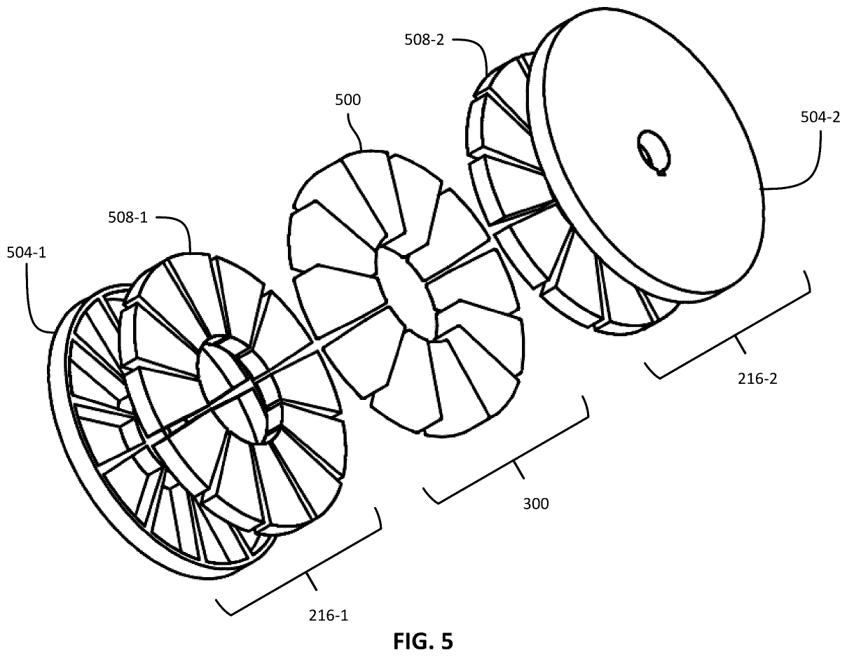

FIG. 3 depicts front plan view of the example generator 112 with the housing 200 omitted, showing the stator 300. The stator 300 is located between the rotors 216-1 and 216-2. Referring to FIG. 4, the stator 300 includes a stator frame 400 fixedly supported on the housing 200, and which can be formed integral to the housing 200 or be fastened to the housing 200, for example, by means of a bolted connection, a welded connection, a bracket connection, by means of an interference fit, etc. The frame 400 is a disc-shaped frame and is provided with a central aperture 404 configured to support bearing arrays 208-3 and 208-4. The frame 400 is further provided with an array of slots 408 configured to support an array of windings such as an example array 500 shown in FIG. 5. The array of windings 500 can be formed, for example, as a copper enameled wire assembly on a silicon steel sheet.

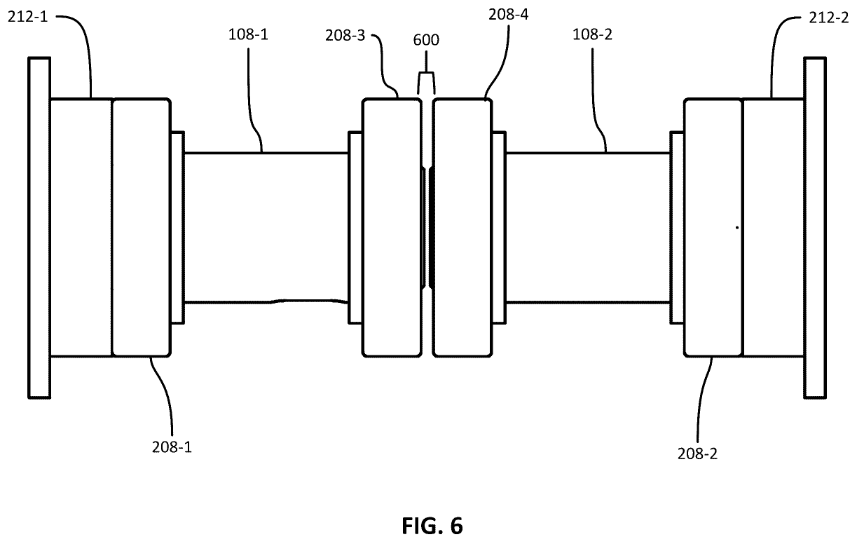

FIG. 5 further shows the rotors 216 formed of disc-shaped rotor frames 504 configured to support arrays of magnets 508, for example, by being provided with an array of slots on which the magnets 508 are supported. The magnets 508 can be permanent magnets, electromagnets or combinations thereof. The generator 112 is thus configured so that as the rotors 216 spin, the magnetic field flux continuously changes along the axial direction of the rotor 216 relative to the windings 500. Due to electromagnetic induction in the stator 300 as a result of the changing magnetic fields acting on the stator 300, a voltage is induced in the windings 500 as it would be apparent to a person skilled in the art. The rotors 216 are configured to be able to rotate independently from each other, as each of the rotors 216 is driven by its own blade assembly 104 and is rotatably supported on the generator 112 independently from the other. FIG. 6 shows a gap 600 defined between ends of the shafts 108 central to the generator 112, within the central aperture 404 on which the bearing arrays 208-3 and 208-4 are supported.

The housing 200 can be provided with a passageway (not depicted in the figures) to route the cabling of the windings 500 out of the generator 112 without the generator 112 needing to be provided with a carbon brush, as the windings 500 are arranged in the stator 300 and therefore are static, thereby avoiding the need to perform maintenance on, or replace the carbon brush. Additionally, a wind turbine such as the example wind turbine 100 or modifications thereof can achieve a greater C_{P}, for example of more than 0.7, with respect to C_{P} achievable by conventional wind turbines. The example wind turbine 100 or modifications thereof can be implemented in different size ranges for different output power ratings such as, for example, in the about 1 to about 10 m blade length range for small wind turbines (P_{turbine}≤100 kW), in the about 10 to about 30 m blade length range for medium wind turbines (100 kW≤P_{turbine}≤1 MW), or in the about 30 to 100+ m blade length range for large wind turbines (P_{turbine}≥1 MW) and can achieve a better utilization of the wind resources, for example, by achieving greater C_{P} values under slower wind conditions such as, for example, in the about 3 to about 10 m/s wind speed range.

Although the invention has been described with reference to certain specific embodiments, various modifications thereof will be apparent to those skilled in the art without departing from the spirit and scope of the invention as outlined in the claims appended thereto. For example, while each of the example shafts 108-1 and 108-2 is rotatably supported on the housing 200 by means of two bearing arrays 208-1 and 208-3, and 208-2 and 208-4, respectively, the example shafts can be alternatively rotatably supported on the housing 200 by means of one bearing array or by a bushing or sleeve bearing each. As a further alternative, the shafts can be rotatably supported on the housing by a mix or bearing arrays and bushings. Furthermore, while gap 600 is defined within a central aperture 404 of the stator frame 400, an alternative stator frame need not have a central aperture and may be provided with other means on opposite circular sides thereof to support the bearing arrays 208-3 and 208-4 or modifications thereof. Furthermore, while the stator and the rotors have been described as having a disc-shape, alternative stators and rotors may have any other suitable shape.

Furthermore, in addition to harvesting wind energy, modifications of the example wind turbine 100 configured so that its blade assemblies rotate in opposite directions with respect to each other, can be implemented to harvest tidal energy instead, to harvest energy during both high and low tide conditions with minimal maintenance requirements. For example, by using corrosion resistant elements such as, for example, carbon fiber, for elements such as blade assemblies, shafts, the housing, etc. and by using, for example, ceramic bearings to prevent corrosion and rust. The magnets can be sealed within the rotor frames, and the array of windings can be implemented in a sealed Printed Circuit Board (PCB) stator, for example with an epoxy resin seal.

The scope of the claims should not be limited by the embodiments set forth in the above examples but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A generator comprising:
a housing;
a stator fixedly supported on the housing;
a first rotor on a first side of the stator supported on a first shaft, the first shaft rotatably supported on the housing; and
a second rotor on a second side of the stator opposite the first rotor, the second rotor supported on a second shaft and configured to rotate independently from the first rotor, the second shaft rotatably supported on the housing.

2. The generator of claim 1 wherein a first blade assembly is supported on the first shaft and a second blade assembly is supported on the second shaft.

3. The generator of claim 2 wherein the first blade assembly is arranged in a direction opposite the second blade assembly.

4. The generator of claim 3 wherein the first blade assembly is configured to rotate in a direction opposite the second blade assembly.

5. The generator of claim 1 wherein the first and the second rotors are colinear with respect to each other.

6. The generator of claim 1 wherein the stator comprises a frame configured to support an array of windings.

7. The generator of claim 6 wherein the frame is disc-shaped.

8. The generator of claim 6 wherein the frame is further configured to rotatably support the shafts.

9. The generator of claim 6 wherein the array of windings are formed in a Printed Circuit Board (PCB).

10. The generator of claim 6 wherein the array of windings are formed as a copper enameled wire assembly on a silicon steel sheet.

11. The generator of claim 1 wherein each of the rotors comprises a disc-shaped frame configured to support and array of permanent magnets.

12. The generator of claim 2 wherein one of the blade assemblies is configured to be an upwind blade assembly and the other of the blade assemblies is a downwind blade assembly with respect to a direction of wind blowing through the generator.
